(19) United States
(12) Patent Application Publication
(10) Pub. No.: US 2025/0123794 A1
(43) Pub. Date: Apr. 17, 2025

(54) SOUND PROVIDING APPARATUS AND METHOD THEREOF

(71) Applicants: Hyundai Motor Company, Seoul (KR); Kia Corporation, Seoul (KR)

(72) Inventor: Kyoung Jin Chang, Suwon-si (KR)

(21) Appl. No.: 18/731,852

(22) Filed: Jun. 3, 2024

(30) Foreign Application Priority Data
Oct. 11, 2023 (KR) 10-2023-0135267

(51) Int. Cl. G06F 3/16; G06V 40/16; G06V 40/20

(52) U.S. Cl. CPC G06F 3/165; G06V 40/171; G06V 40/174; G06V 40/20

(57) ABSTRACT

An embodiment sound providing apparatus includes a camera, one or more processors, and a storage device storing a program to be executed by the one or more processors, the program including instructions to obtain a face image of each passenger in a vehicle using the camera, determine a conversation state of each passenger based on the face image of each passenger, determine an emotional state of each passenger based on the face image of each passenger, determine a conversation atmosphere based on the conversation state and the emotional state of each passenger, select a sound source mapped to the conversation atmosphere, and play and output the sound source.

### CROSS-REFERENCE TO RELATED APPLICATIONS

This application claims the benefit of Korean Patent Application No. 10-2023-0135267, filed on Oct. 11, 2023, which application is hereby incorporated herein by reference.

### TECHNICAL FIELD

The present disclosure relates to a sound providing apparatus and a method thereof.

### BACKGROUND

As there has been an increase in the use of a vehicle, the time spent in the vehicle has also increased. Thus, technologies for recognizing an emotional state of a driver of the vehicle, a surrounding environment of the vehicle, or the like and providing music which matches the recognized emotional state, the recognized surrounding environment, or the like have been studied and developed.

However, because such a sound providing technology provides music with regard to an emotional state of a specific person (e.g., the driver) in the vehicle, the surrounding environment of the vehicle, or the like, conversation between the driver and the passenger in the vehicle may fail to be smoothly performed due to provided music, when the driver proceeds with talking to the passenger in the vehicle.

### SUMMARY

The present disclosure relates to a sound providing apparatus and a method thereof. Particular embodiments relate to a sound providing apparatus for providing music which matches a conversation atmosphere of passengers in a vehicle and a method thereof.

Embodiments of the present disclosure can solve problems occurring in the prior art while advantages achieved by the prior art are maintained intact.

An embodiment of the present disclosure provides a sound providing apparatus for recognizing a conversation atmosphere of passengers who ride in a vehicle and providing music which matches the recognized conversation atmosphere and a method thereof.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a sound providing apparatus may include a camera and a processor. The processor may obtain a face image of each of at least one passenger in a vehicle using the camera, may determine a conversation state of the at least one passenger based on the face image of each of the at least one passenger, may determine an emotional state of the at least one passenger based on the face image of each of the at least one passenger, may determine a conversation atmosphere based on the conversation state and the emotional state of the at least one passenger, may select at least one sound source mapped to the conversation atmosphere, and may play and output the selected at least one sound source.

The processor may extract positions of at least some mouth feature points from the face image of each of the at least one passenger, may calculate a lip aspect ratio based on the positions of the at least some mouth feature points, may determine whether lips are open based on the lip aspect ratio, may count a lip opening count for each passenger based on the result of determining whether the lips are open, may calculate a conversation rate for each passenger based on the lip opening count for each passenger, and may calculate an average conversation rate of the at least one passenger based on the conversation rate for each passenger.

The processor may extract the positions of the at least some mouth feature points using a face feature point detection algorithm.

The processor may extract positions of at least some mouth feature points from the face image of each of the at least one passenger, may determine a lip open state value for each passenger based on the positions of the at least some mouth feature points using an artificial intelligence (AI) algorithm, may calculate a conversation rate for each passenger based on the lip open state value for each passenger, and may calculate an average conversation rate of the at least one passenger based on the conversation rate for each passenger.

The processor may recognize a facial expression for each passenger from the face image of each of the at least one passenger, may estimate an emotion array probability for each passenger based on the facial expression for each passenger, may calculate an emotion rate for each passenger based on the emotion array probability for each passenger, and may calculate an average emotion rate of the at least one passenger based on the emotion rate for each passenger.

The processor may determine at least one higher emotion with a high probability in the average emotion rate of the at least one passenger as the emotional state of the at least one passenger.

The processor may redetermine a conversation state of the at least one passenger while playing the at least one sound source and may adjust the volume of the sound source which is being played based on the redetermined conversation state of the at least one passenger.

The processor may redetermine a conversation atmosphere of the at least one passenger if the playback of the sound source which is being played is ended, may newly select at least one sound source mapped to the redetermined conversation atmosphere of the at least one passenger, and may play the newly selected at least one sound source.

The processor may redetermine a conversation atmosphere of the at least one passenger while playing the at least one sound source, may newly select at least one sound source mapped to the redetermined conversation atmosphere of the at least one passenger, and may fade out the sound source which is being played and may fade in and play the newly selected at least one sound source.

The processor may adjust the volume of the sound source which is being played based on the conversation atmosphere of the at least one passenger.

According to an embodiment of the present disclosure, a sound providing method may include obtaining a face image of each of at least one passenger in a vehicle using a camera, determining a conversation state of the at least one passenger based on the face image of each of the at least one passenger, determining an emotional state of the at least one passenger based on the face image of each of the at least one passenger, determining a conversation atmosphere based on the conversation state and the emotional state of the at least one passenger, selecting at least one sound source mapped to the conversation atmosphere, and playing and outputting the selected at least one sound source.

The determining of the conversation state of the at least one passenger may include extracting positions of at least some mouth feature points from the face image of each of the at least one passenger, calculating a lip aspect ratio based on the positions of the at least some mouth feature points, determining whether lips are open based on the lip aspect ratio, counting a lip opening count for each passenger based on the result of determining whether the lips are open, calculating a conversation rate for each passenger based on the lip opening count for each passenger, and calculating an average conversation rate of the at least one passenger based on the conversation rate for each passenger.

The extracting of the positions of the at least some mouth feature points may include extracting the positions of the at least some mouth feature points using a face feature point detection algorithm.

The determining of the conversation state of the at least one passenger may include extracting positions of at least some mouth feature points from the face image of each of the at least one passenger, determining a lip open state value for each passenger based on the positions of the at least some mouth feature points using an AI algorithm, calculating a conversation rate for each passenger based on the lip open state value for each passenger, and calculating an average conversation rate of the at least one passenger based on the conversation rate for each passenger.

The determining of the emotional state of the at least one passenger may include recognizing a facial expression for each passenger from the face image of each of the at least one passenger, estimating an emotion array probability for each passenger based on the facial expression for each passenger, calculating an emotion rate for each passenger based on the emotion array probability for each passenger, and calculating an average emotion rate of the at least one passenger based on the emotion rate for each passenger.

The determining of the emotional state of the at least one passenger may include determining at least one higher emotion with a high probability in the average emotion rate of the at least one passenger as the emotional state of the at least one passenger.

The sound providing method may further include redetermining a conversation state of the at least one passenger while playing the at least one sound source and adjusting the volume of the sound source which is being played based on the redetermined conversation state of the at least one passenger.

The sound providing method may further include redetermining a conversation atmosphere of the at least one passenger if the playback of the sound source which is being played is ended, newly selecting at least one sound source mapped to the redetermined conversation atmosphere of the at least one passenger, and playing the newly selected at least one sound source.

The sound providing method may further include redetermining a conversation atmosphere of the at least one passenger while playing the at least one sound source, newly selecting at least one sound source mapped to the redetermined conversation atmosphere of the at least one passenger, and fading out the sound source which is being played and fading in and playing the newly selected at least one sound source.

The sound providing method may further include determining the volume of the sound source which is being played based on the conversation atmosphere of the at least one passenger.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a block diagram illustrating a configuration of a sound providing apparatus according to embodiments of the present disclosure;

FIG. 2 is a drawing illustrating face feature points associated with embodiments of the present disclosure;

FIG. 3 is a flowchart illustrating a sound providing method according to embodiments of the present disclosure;

FIG. 4 is a flowchart illustrating a process of determining a conversation state according to an embodiment of the present disclosure;

FIG. 5 is a flowchart illustrating a process of calculating a conversation rate according to another embodiment of the present disclosure;

FIG. 6 is a flowchart illustrating a process of calculating an emotional state according to embodiments of the present disclosure;

FIG. 7 is a flowchart illustrating a process of analyzing a conversation atmosphere according to an embodiment of the present disclosure;

FIG. 8 is a flowchart illustrating a process of analyzing a conversation atmosphere according to another embodiment of the present disclosure;

FIG. 9 is a block diagram illustrating a sound providing system according to another embodiment of the present disclosure; and

FIGS. 10 and 11 are drawings illustrating an example of a display screen of a user interface device according to another embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical component is designated by the identical numeral even when it is displayed on other drawings. In addition, a detailed description of well-known features or functions will be omitted in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but they do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art and are not to be interpreted as having ideal or excessively formal meanings unless clearly defined as having such in the present application.

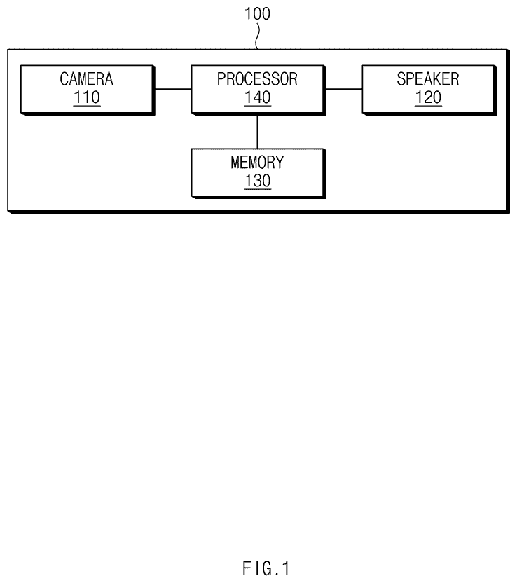

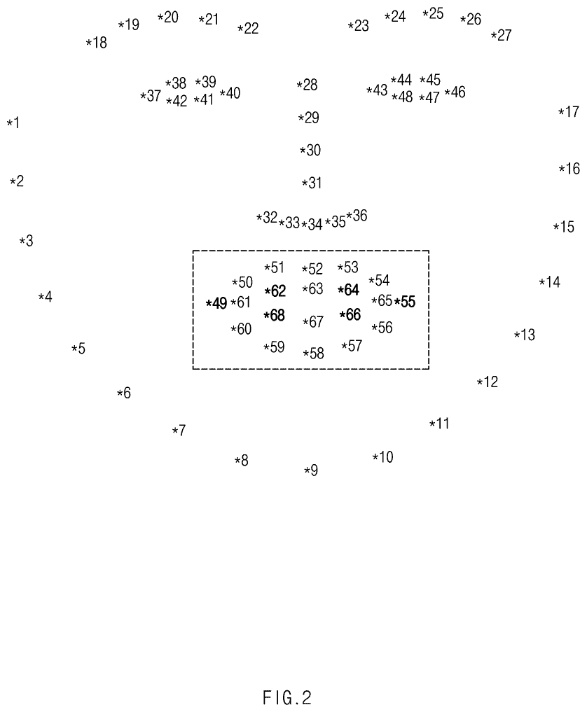

FIG. 1 is a block diagram illustrating a configuration of a sound providing apparatus according to embodiments of the present disclosure. FIG. 2 is a drawing illustrating face feature points associated with embodiments of the present disclosure.

A sound providing apparatus 100 may be mounted on a vehicle. The sound providing apparatus 100 may include a camera 110, a speaker 120, a memory 130, and a processor 140.

The camera 110 may be loaded into the vehicle. The camera 110 may capture a passenger (e.g., a driver, another passenger, and/or the like) who rides in a front seat and/or a rear seat of the vehicle. The camera 110 may include at least one image sensor loaded into the vehicle. For example, the camera 110 may include a first image sensor for capturing a passenger sitting in the front seat of the vehicle and a second image sensor for capturing a passenger sitting in the rear seat of the vehicle. At least two or more image sensors may be implemented as a charge coupled device (CCD) image sensor, a complementary metal oxide semiconductor (CMOS) image sensor, a charge priming device (CPD) image sensor, a charge injection device (CID) image sensor, and/or the like. The camera 110 may include an image processor for performing image processing, such as noise cancellation, color reproduction, file compression, image quality adjustment, and saturation adjustment, for an image obtained using the image sensor. The image processor may extract and output a face image from the image obtained by the image sensor.

The at least one speaker 120 may be disposed (or embedded) in the vehicle. The speaker 120 may output an audio signal to the interior of the vehicle. The speaker 120 may include a voice coil and a diaphragm. The voice coil may receive and deliver the audio signal (or an electrical signal) to the diaphragm. When current flows in the voice coil, air may vibrate using the diaphragm connected while moving up and down by an electromagnetic force to generate a sound.

The memory 130 may be a non-transitory storage medium which stores instructions executed by the processor 140. The memory 130 may include a flash memory, a hard disk, a solid state disk (SSD), a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), and/or the like.

The memory 130 may store a face feature point detection algorithm (or model), a facial expression recognition algorithm, a conversation prediction artificial intelligence (AI) model, an emotion estimation AI model, a conversation atmosphere determination algorithm, and/or the like.

The memory 130 may store a lookup table in which a conversation atmosphere variable Eg according to a conversation rate Ri and a maximum emotion Mm is defined. The memory 130 may store a lookup table in which a sound source and a volume according to a conversation atmosphere variable are stored. The memory 130 may store at least one sound source matched for each conversation atmosphere. The memory 130 may classify and store a sound source depending on a sound source category and/or a music genre (or type).

The memory 130 may store the image obtained by the camera 110 or may store input data, output data, and/or the like according to an operation of the processor 140.

The processor 140 may be coupled to the camera 110, the speaker 120, and the memory 130. The processor 140 may interact with the camera 110, the speaker 120, and the memory 130 to control the overall operation of the sound providing apparatus 100. The processor 140 may be implemented as at least one of processing devices such as an application specific integrated circuit (ASIC), a digital signal processor (DSP), a programmable logic device (PLD), a field programmable gate array (FPGA), a central processing unit (CPU), a microcontroller, or a microprocessor.

The processor 140 may pre-train the face feature point detection model for detecting face feature point coordinates (or a face feature point position) from a passenger face image using an AI algorithm, such as a convolutional neural network (CNN). Furthermore, the processor 140 may also pre-train the conversation prediction AI model. The processor 140 may pre-train the emotion estimation AI model for estimating an emotional state from a face image of a passenger using an AI algorithm, such as a CNN, a multi-task cascaded convolutional neural network (MTCNN), and/or mini-Xception. The processor 140 may store the trained result, that is, the trained model in the memory 130.

The processor 140 may define the conversation atmosphere variable Eg according to the conversation rate Ri and the maximum emotion Mm using a user evaluation or the like and may store the conversation atmosphere variable Eg in the form of a lookup table in the memory 130. Furthermore, the processor 140 may store at least one sound source (i.e., background music) matched with the conversation atmosphere variable in the memory 130. The conversation atmosphere variable may be a keyword comprehensively representing a conversation state and an emotional state.

When at least one passenger (e.g., a driver, a passenger, another passenger, and/or the like) in the vehicle is detected, the processor 140 may identify the number of persons which ride in the vehicle. The processor 140 may detect a passenger in the vehicle using a pressure sensor mounted on a seat of the vehicle and/or the camera 110. When the at least one passenger in the vehicle is detected, the processor 140 may execute a conversation atmosphere analysis function. When the conversation atmosphere analysis function is executed, the processor 140 may determine a conversation atmosphere of passengers based on a predetermined conversation atmosphere determination period.

The processor 140 may obtain a face image of the at least one passenger using the camera 110. The processor 140 may obtain at least one face image for the at least one passenger using the camera 110 at a predetermined detection period (or a sampling period).

The processor 140 may estimate a lip shape from the face image of the at least one passenger. The processor 140 may detect mouth feature information (e.g., mouth feature point coordinates) from the face image. The processor 140 may estimate a lip shape from the detected mouth feature information. Referring to FIG. 2, the processor 140 may extract face feature points from a face image of each passenger using the face feature point detection model (e.g., the face feature point 68 model). The processor 140 may extract at least some mouth feature points among the extracted face feature points. For example, the processor 140 may extract all of 20 mouth feature points 49 to 68 among 68 face feature points. Furthermore, the processor 140 may extract 6 mouth feature points 49, 55, 62, 64, 66, and 68 among the 20 mouth feature points 49 to 68. The processor 140 may analyze coordinates (or positions) of the extracted at least some mouth feature points and may estimate a lip shape.

The processor 140 may determine whether the passenger has his or her mouth open or closed from the estimated lip shape. The processor 140 may determine whether the passenger has his or her mouth open or closed based on a distance between an upper lip feature point and a lower lip feature point among the extracted mouth feature points. The processor 140 may calculate a lip aspect ratio based on the coordinates of the extracted mouth feature points and may determine whether the passenger has his or her mouth open or closed based on the calculated lip aspect ratio. The processor 140 may determine the lip state as an open state, when it is determined that the passenger has the mouth open, and may determine the lip state as a closed state, when it is determined that the passenger has the mouth closed.

The processor 140 may calculate a conversation rate for each passenger based on lip state information for each passenger. The processor 140 may calculate an average conversation rate of all of at least one passenger (or all passengers) using the calculated conversation rate for each passenger.

The processor 140 may recognize a facial expression for each passenger from the obtained face image of the at least one passenger. The processor 140 may determine an emotional state (or an emotion rate) for each passenger based on the recognized facial expression for each passenger. The processor 140 may determine an average emotional state (or an average emotion rate) of all the passengers based on the determined emotional state for each passenger.

The processor 140 may determine a conversation state of all the passengers based on the average conversation rate of all the passengers. Furthermore, the processor 140 may determine an emotional state of all the passengers based on the average conversation rate of all the passengers. The processor 140 may determine at least one higher emotion with a high emotion probability in the average emotion rate of all the passengers as the emotional state of all the passengers.

The processor 140 may determine a conversation atmosphere of at least one passenger based on the determined conversation state and the determined emotional state of all the passengers. The processor 140 may determine a conversation atmosphere variable according to the conversation state and the emotional state using the lookup table previously stored in the memory 130.

The processor 140 may select at least one sound source mapped to the conversation atmosphere among the sound sources stored in the memory 130. The processor 140 may select at least one sound source mapped to the determined conversation atmosphere variable as background music. The processor 140 may sequentially or randomly play the selected at least one sound source. The processor 140 may output the played sound source to the interior of the vehicle through the speaker 120. Furthermore, the processor 140 may determine the volume of the played sound source based on the determined conversation atmosphere.

The processor 140 may determine whether the playback of the sound source which is being currently played is ended. When it is determined that the playback of the sound source which is being currently played is not ended, the processor 140 may determine a conversation state of the at least one passenger. The processor 140 may adjust the volume of the played sound source based on the determined conversation state of the at least one passenger.

Meanwhile, when it is determined that the playback of the sound source which is being currently played is ended, the processor 140 may redetermine a conversation state and an emotional state of the at least one passenger. The processor 140 may redetermine a conversation atmosphere based on the redetermined conversation state and the redetermined emotional state. The processor 140 may newly select at least one sound source mapped to the redetermined conversation atmosphere. The processor 140 may play and output the newly selected at least one sound source to the interior of the vehicle through the speaker 120.

Furthermore, the processor 140 may redetermine a conversation state and an emotional state of the at least one passenger while playing the sound source. The processor 140 may newly select at least one sound source mapped to the redetermined conversation atmosphere. The processor 140 may fade out the sound source which is being currently played and may fade in the newly selected at least one sound source. The processor 140 may adjust the volume of the played sound source based on the determined conversation state when playing the sound source.

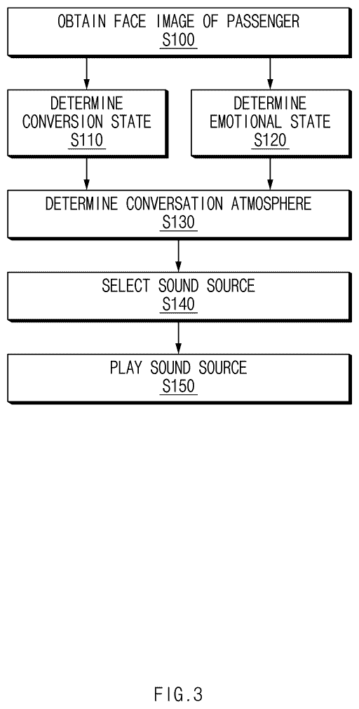

FIG. 3 is a flowchart illustrating a sound providing method according to embodiments of the present disclosure.

In S100, the processor 140 may obtain a face image of at least one passenger in a vehicle using the camera 110. When at least one passenger rides in the vehicle, the processor 140 may obtain a face image of each passenger using the camera 110.

In S110, the processor 140 may determine a conversation state for each passenger from the obtained face image. The processor 140 may recognize a lip state for each passenger from the face image for each passenger. In other words, the processor 140 may analyze the face image for each passenger and may determine whether each passenger has his or her mouth open or closed. The lip state may be divided into a lip-open state in which the mouth is open and a lip-closed state in which the mouth is closed. The processor 140 may determine the conversation state of at least one passenger based on the recognized lip state.

In S120, the processor 140 may determine an emotional state for each passenger from the obtained face image. The processor 140 may recognize a facial expression for each passenger from the obtained face image using a facial expression recognition algorithm. The processor 140 may determine the emotional state for each passenger based on the recognized facial expression for each passenger.

In S130, the processor 140 may determine a conversation atmosphere of at least one passenger based on the conversation state for each passenger and the emotional state for each passenger. The processor 140 may determine a conversation atmosphere of all of the at least one passenger with regard to the conversation state and the emotional state of each of the at least one passenger.

In S140, the processor 140 may select at least one sound source mapped to the determined conversation atmosphere. The processor 140 may determine a category (or a folder) mapped to the conversation atmosphere and may select at least one sound source included in the determined category as background music. The processor 140 may determine the volume of the sound source based on the determined conversation atmosphere.

In S150, the processor 140 may play the selected at least one sound source. The processor 140 may sequentially or randomly play the selected at least one sound source. The processor 140 may output an audio signal of the played sound source to the interior of the vehicle through the speaker 120.

According to the above-mentioned embodiment, the sound providing apparatus 100 may automatically select music which matches a conversation atmosphere of at least one passenger in the vehicle and may adjust the volume of the music to provide the music, thus improving passenger satisfaction as the passenger is able to focus on conversation or his or her own interests and providing a feeling of luxury and care.

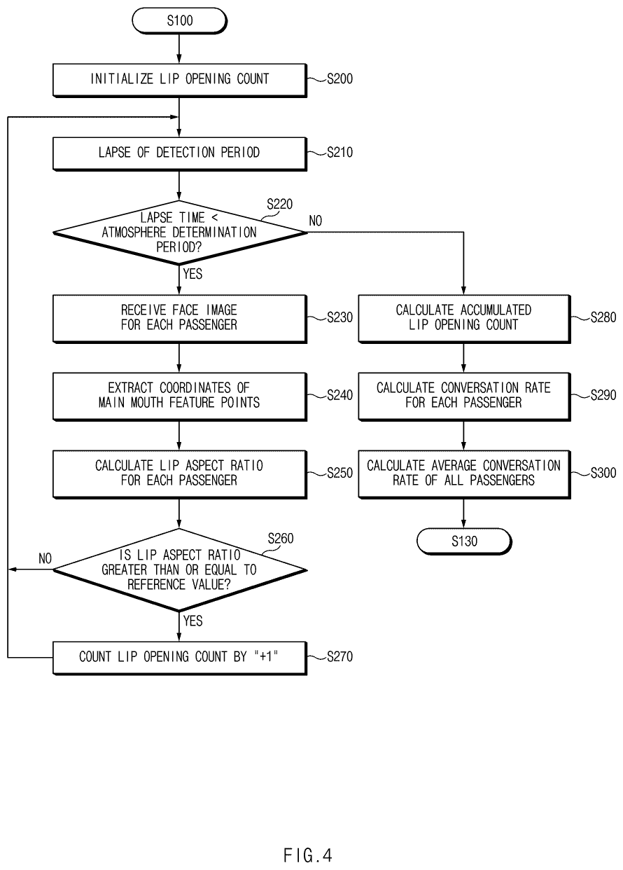

FIG. 4 is a flowchart illustrating a process of determining a conversation state according to an embodiment of the present disclosure.

In S200, the processor 140 may initialize a lip opening count No (i) to “0”, when initiating to determine a conversation state. The lip opening count No (i) may be defined as the number of times that it is determined that the lips of an ith passenger are open during a detection period. Herein, i may be a number (or a passenger identification number) allocated to a passenger to distinguish a passenger, which may be assigned from “1” to the number Nt of vehicle passengers. The processor 140 may operate a timer (not shown) to measure a lapse time after initiating to determine the conversation state.

In S210, the processor 140 may wait until the detection period (e.g., 0.2 seconds to 0.5 seconds) elapses. The detection period may be a period for detecting whether the lips are open, which may be predetermined by a system designer.

In S220, the processor 140 may determine whether the lapse time is less than an atmosphere determination period Ta. The processor 140 may measure a time (or a lapse time) which elapses after initiating to determine the conversation state using the timer (not shown). The processor 140 may calculate a lapse time based on the number of times that the detection period elapses. The processor 140 may determine whether the atmosphere determination period (e.g., about 20 to 30 seconds) elapses based on the lapse time. The atmosphere determination period may be a period for determining a conversation atmosphere based on a lip opening count, which may be predetermined by the system designer.

When it is determined that the lapse time is less than the atmosphere determination period, in S230, the processor 140 may receive a face image for each passenger from the camera 110. The camera 110 may transmit at least one face image for each passenger, which is captured during the detection period, to the processor 140. The processor 140 may receive at least one face image for each passenger, which is transmitted from the camera 110. The present embodiment describes the example in which the processor 140 receives the face image for each passenger from the camera 110, but it is not limited thereto. The processor 140 may be implemented to access a face image for each passenger from the memory 130. For example, the camera 110 may capture and store a face image for each passenger in the memory 130. The processor 140 may read the face image for each passenger which is stored in the memory 130.

In S240, the processor 140 may extract coordinates of main mouth feature points from the received face image. The main mouth feature points may be defined as a minimum number of mouth feature points necessary to determine whether lips are open. The main mouth feature points may include mouth left and right edge coordinates (49, 55), upper lip left and right coordinates (62, 64), and lower lip left and right coordinates (68, 66) (refer to FIG. 2).

In S250, the processor 140 may calculate a lip aspect ratio for each passenger based on the extracted coordinates of the main mouth feature points. The processor 140 may calculate a lip aspect ratio Rₘₒᵤₜₕ using Equation 1 below.

$${R}_{mouth} = \frac{( A + B )}{2 * C} \qquad Equation 1$$

Herein, A is the Euclidean distance between the upper lip left coordinate 62 and the lower lip left coordinate 68, B is the Euclidean distance between the upper lip right coordinate 64 and the lower lip right coordinate 66, and C is the Euclidean distance between the mouth left and right edge coordinates (49, 55). The Euclidean distance may be indicated as a square root of a sum of squares of each coordinate axis distance difference between two points.

In S260, the processor 140 may determine whether the calculated lip aspect ratio for each passenger is greater than or equal to a reference value. The reference value may be a value (e.g., 0.08 to 0.12) which is a criterion for determining whether the lips are open, which may be predetermined by the system designer. The processor 140 may compare the calculated lip aspect ratio with the reference value and may determine whether the lips are open based on the compared result. When the calculated lip aspect ratio is greater than or equal to the reference value, the processor 140 may determine that the lips are open. Furthermore, when the lip aspect ratio is less than the reference value, the processor 140 may determine that the lips are closed. When it is determined that the lips are closed, the processor 140 may return to S210.

When it is determined that the calculated lip aspect ratio is greater than or equal to the reference value, in S270, the processor 140 may count a lip opening count of the passenger by “+1”. When it is determined that the lips are open, the processor 140 may increase a lip opening count of the passenger determined that the lips are open by “+1”. Thereafter, the processor 140 may return to S210.

When it is determined that the lapse time is not less than the atmosphere determination period in S220, in S280, the processor 140 may calculate an accumulated lip opening count Nos(i) for each passenger. The processor 140 may calculate the number of times N that a lip opening count of an ith passenger is detected (or a detection number N) during an atmosphere determination period Ta. The detection number N may be a floor value of a value obtained by dividing the atmosphere determination period Ta by the detection period Ts. The processor 140 may add the lip opening count of the ith passenger, which is detected by repeating the detection number N, to calculate the accumulated lip opening count Nos(i) for each passenger.

In S290, the processor 140 may calculate a conversation rate Ri(i) for each passenger based on the accumulated lip opening count Nos(i) for each passenger. The conversation rate Ri(i) for each passenger may be a rate (e.g., 0≤Ri(i)≤1) at which the lips of the ith passenger are open on average during the atmosphere determination period. The processor 140 may calculate the conversation rate Ri(i) for each passenger using Equation 2 below.

$$Ri ( i ) = \frac{Nos ( i )}{N} \qquad Equation 2$$

In S300, the processor 140 may calculate an average conversation rate Rt of all passengers based on the conversation rate Ri(i) for each passenger. The average conversation rate Rt of all the passengers may be an average conversation rate (e.g., 0≤Rt≤1) of all the passengers during the atmosphere determination period. The processor 140 may calculate the average conversation rate Rt of all the passengers using Equation 3 below.

$$Rt = {\sum }_{i = 1}^{Nt} Ri ( i ) \div Nt \qquad Equation 3$$

Thereafter, the processor 140 may determine a conversation state value based on the average conversation rate Rt of all the passengers. The conversation state value may be determined between 0 and 10. When the conversation state value is 0, the processor 140 may determine that there is no conversation. The processor 140 may determine that there is an intermittent conversation state when the conversation state value is between 1 and 9 and may determine that there is an intense conversation state when the conversation state value is 10.

According to the above-mentioned embodiment, the technology of determining a conversation state (or a conversation frequency) based on whether the lips of the passenger are open is insensitive to noise compared to a technology of determining a conversation state using speech recognition and does not need to install a microphone.

Furthermore, according to the above-mentioned embodiment, the technology of determining the conversation state based on whether the lips of the passenger are open may determine a conversation state for each passenger and may be expanded and applied to an individual service for each passenger, for example, providing music for each passenger, changing illumination for each passenger, or changing a seat space for each passenger, other than providing background music.

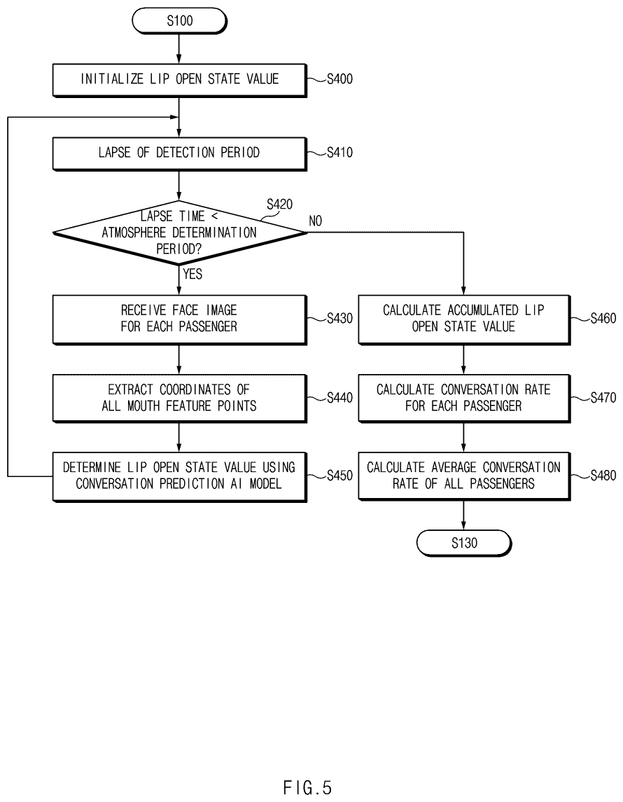

FIG. 5 is a flowchart illustrating a process of calculating a conversation rate according to another embodiment of the present disclosure.

In S400, the processor 140 may initialize a lip open state value Np(j, i) to “0” when initiating to determine a conversation state. The lip open state value Np(j, i) may be a state value indicating a lip open state of an ith passenger in a jth detection round. Herein, i may be a number (or a passenger identification number) allocated to a passenger to distinguish the passenger, which may be assigned from “1” to the number Nt of vehicle passengers. j may be a lip state detection round, which may be assigned from “1” to a detection number N. The detection number N may be a floor value of a value obtained by dividing an atmosphere determination period Ta by a detection period Ts. The processor 140 may operate a timer (not shown) to measure a lapse time after initiating to determine the conversation state.

In S410, the processor 140 may wait until the detection period (e.g., 0.2 seconds to 0.5 seconds) elapses. The detection period may be a period for detecting whether the lips are open, which may be predetermined by the system designer.

In S420, the processor 140 may determine whether the lapse time is less than the atmosphere determination period Ta. The processor 140 may measure a time (or a lapse time) which elapses after initiating to determine the conversation state using the timer (not shown). The processor 140 may calculate a lapse time based on the number of times that the detection period elapses. The processor 140 may determine whether the atmosphere determination period (e.g., about 20 to 30 seconds) elapses based on the lapse time. The atmosphere determination period may be a period for determining a conversation atmosphere based on a lip open state, which may be predetermined by the system designer.

When it is determined that the lapse time is less than the atmosphere determination period, in S430, the processor 140 may receive a face image for each passenger from the camera 110. The camera 110 may transmit a face image of each passenger, which is captured during the detection period, to the processor 140. The processor 140 may receive the face image of each passenger which is transmitted from the camera 110. The present embodiment describes the example in which the processor 140 receives the face image for each passenger from the camera 110, but it is not limited thereto. The processor 140 may be implemented to access a face image for each passenger from the memory 130. For example, the camera 110 may capture and store a face image for each passenger in the memory 130. The processor 140 may read the face image for each passenger which is stored in the memory 130.

In S440, the processor 140 may extract coordinates of all mouth feature points from the received face image. The mouth feature points may be all mouth feature points necessary to estimate a lip shape. The processor 140 may extract face feature points shown in FIG. 2 using a face feature point detection model. Furthermore, the processor 140 may extract 20 mouth feature points 49 to 68 among the face feature points.

In S450, the processor 140 may determine a lip open state Np(j, i) for each passenger based on the extracted coordinates of the mouth feature points. The processor 140 may determine the lip open state Np(j, i) for each passenger using a conversation prediction AI model. An artificial neural network model, a Gaussian process regression model, a principal component regression model, and/or the like may be used as the conversation prediction AI model.

When it is determined that the lapse time is not less than the atmosphere determination period in S420, in S460, the processor 140 may calculate an accumulated lip open state value Nps(i) for each passenger. The processor 140 may calculate the number N of times that a lip open state value of an ith passenger is detected (or a detection number N) during an atmosphere determination period Ta. The processor 140 may add the lip open state value Np(j, i) of the ith passenger, which is detected by repeating the detection number N, to calculate the accumulated lip open state value Nps(i) for each passenger. The accumulated lip open state value Nps(i) for each passenger may be represented as Equation 4 below.

$$Nps ( i ) = {\sum }_{j = 1}^{N} Np ( j , i ) \qquad Equation 4$$

In S470, the processor 140 may calculate a conversation rate Ri(i) for each passenger based on the accumulated lip open state value Nps(i) for each passenger. The conversation rate Ri(i) for each passenger may be a rate (e.g., 0≤Ri(i)≤1) at which the lips of the ith passenger are open on average during the atmosphere determination period. The processor 140 may calculate the conversation rate Ri(i) for each passenger using Equation 5 below.

$$Ri ( i ) = \frac{Nps ( i ) \times 0.1}{N} \qquad Equation 5$$

In S480, the processor 140 may calculate an average conversation rate Rt of all passengers based on the conversation rate Ri(i) for each passenger. The average conversation rate Rt of all the passengers may be an average conversation rate (e.g., 0≤Rt≤1) of all the passengers during the atmosphere determination period. The processor 140 may calculate the average conversation rate Rt of all the passengers using Equation 3 above.

Thereafter, the processor 140 may determine a conversation state value based on the average conversation rate Rt of all the passengers. The conversation state value may be determined between 0 and 10. When the conversation state value is 0, the processor 140 may determine that there is no conversation. The processor 140 may determine that there is an intermittent conversation state when the conversation state value is between 1 and 9 and may determine that there is an intense conversation state when the conversation state value is 10.

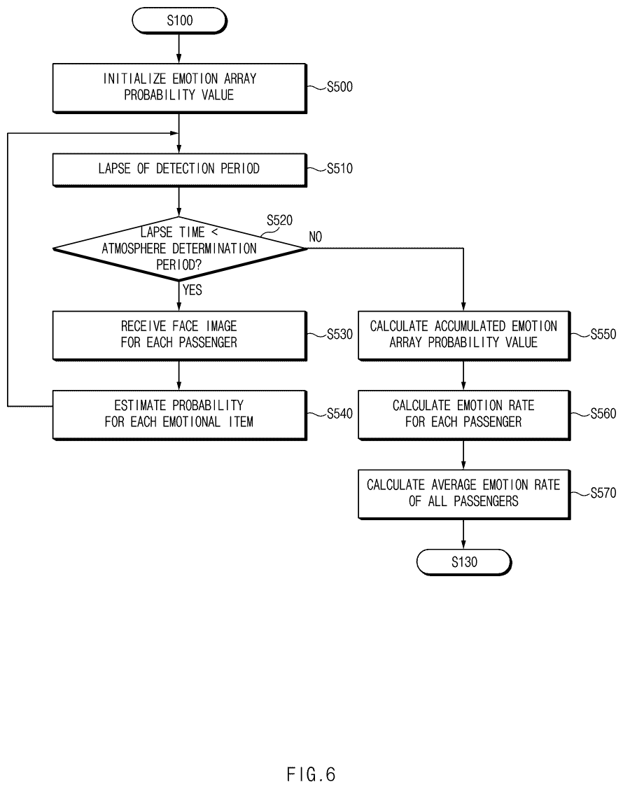

FIG. 6 is a flowchart illustrating a process of calculating an emotional state according to embodiments of the present disclosure.

In S500, the processor 140 may initialize an emotion array probability value Em(j, k, i), when initiating to determine an emotional state. The emotion array probability value Em(j, k, i) may be an emotion probability in which a kth emotion is estimated from a passenger face in a jth detection round for an ith passenger.

In S510, the processor 140 may wait until the detection period (e.g., 0.2 seconds to 0.5 seconds) elapses. The detection period may be a period for detecting a facial expression, which may be predetermined by the system designer.

In S520, the processor 140 may determine whether a lapse time is less than an atmosphere determination period Ta. The processor 140 may measure a time (or a lapse time) which elapses after initiating to determine the emotional state using a timer (not shown). The processor 140 may determine whether the atmosphere determination period (e.g., about 20 to 30 seconds) elapses based on the lapse time. The atmosphere determination period may be a period for determining a conversation atmosphere based on the emotional state, which may be predetermined by the system designer.

When it is determined that the lapse time is less than the atmosphere determination period Ta, in S530, the processor 140 may receive a face image of at least one passenger which is captured in the detection period.

In S540, the processor 140 may estimate a probability for each emotional item, that is an emotion array probability value Em(j, k, i) for each passenger from the face image for each passenger using an emotional state estimation AI model. An emotion array may include predetermined m emotional items (e.g., joy, sadness, anger, surprise, calm, and the like). Herein, j may be a detection round, k may be an emotion number, and i may be a passenger number. An AI algorithm, such as a CNN or a MTCNN, may be used as the emotional state estimation AI model.

When it is determined that the lapse time is not less than the atmosphere determination period in S520, in S550, the processor 140 may calculate an accumulated emotion array probability value Ems(j, k, i) for each passenger. The accumulated emotion array probability value Ems(j, k, i) for each passenger may be represented as Equation 6 below.

$$Ems ( k , i ) = {\sum }_{j = 1}^{N} Em ( j , k , i ) \qquad Equation 6$$

In S560, the processor 140 may calculate an emotion rate Rm(k, i) for each passenger based on the accumulated emotion array probability value Ems(j, k, i) for each passenger. The emotion rate Rm(k, i) for each passenger may be a value (e.g., 0≤Rm(k, i)≤1) obtained by averaging probabilities generated during the atmosphere determination period for a kth emotional item of the ith passenger. The processor 140 may calculate the emotion rate Rm(k, i) for each passenger using Equation 7 below.

$$Rm ( k , i ) = \frac{Ems ( k , i )}{N} \qquad Equation 7$$

In S480, the processor 140 may calculate an average emotion rate Rtm(k) of all passengers based on the emotion rate Rm(k, i) for each passenger. The average emotion rate Rtm(k) of all the passengers may be an average emotion rate (e.g., 0≤Rtm(k)≤1) of all the passengers for the kth emotional item during the atmosphere determination period. The processor 140 may calculate an average emotion rate Rtm of all the passengers using Equation 8 below.

$$Rtm ( k ) = {\sum }_{i = 1}^{Nt} \frac{Rm ( k , i )}{Nt} \qquad Equation 8$$

When the emotional item m in the emotion array is divided into 5 types such as joy, sadness, anger, surprise, and calm, the processor 140 may calculate an emotion probability Em(j, k, i) of the kth emotion of the ith passenger in the jth detection round. When a probability that a No. 2 passenger will have a joy emotion (or a first emotion) in a first detection round, a probability that the No. 2 passenger will have a sadness emotion (or a second emotion) in the first detection round, a probability that the No. 2 passenger will have an anger emotion (or a third emotion) in the first detection round, a probability that the No. 2 passenger will have a surprise emotion (or a fourth emotion) in the first detection round, and a probability that the No. 2 passenger will have a calm emotion (or a fifth emotion) in the first detection round are 20%, 5%, 24%, 30%, and 50%, respectively, the processor 140 may determine the emotion array probability value Em(1, 1, 2) of the No. 2 passenger as 0.2, may determine the emotion array probability value Em(1, 2, 2) of the No. 2 passenger as 0.05, may determine the emotion array probability value Em(1, 3, 2) of the No. 2 passenger as 0.24, may determine the emotion array probability value Em(1, 4, 2) of the No. 2 passenger as 0.3, and may determine the emotion array probability value Em(1, 5, 2) of the No. 2 passenger as 0.5. The processor 140 may accumulate the emotion probability value for each passenger for the 5 emotions, which is calculated in all the detection rounds, and may divide the accumulated emotion probability by the detection number N to calculate an accumulated emotion array probability value Ems(k, i). For example, the processor 140 may add a first emotion probability Em(1, 1, i) calculated in a first detection round, a first emotion probability Em(2, 1, i) calculated in a second detection round, and a first emotion probability Em(3, 1, i) calculated in a third detection round and may divide the added value by the detection number N(=3) to calculate an accumulated emotion array probability value Ems(1, i). Assuming that an accumulated emotion array probability value Ems(1, 1) for a No. 1 passenger is 0.7, that an accumulated emotion array probability value Ems(2, 1) for the No. 1 passenger is 0.3, that an accumulated emotion array probability value Ems(3, 1) for the No. 1 passenger is 0.2, that an accumulated emotion array probability value Ems(4, 1) for the No. 1 passenger is 0.8, and that an accumulated emotion array probability value Ems(5, 1) for the No. 1 passenger is 0.1, a first emotion probability of the No. 1 passenger may refer to 70%, a second emotion probability of the No. 1 passenger may refer to 30%, a third emotion probability of the No. 1 passenger may refer to 20%, a fourth emotion probability of the No. 1 passenger may refer to 80%, and a fifth emotion probability of the No. 1 passenger may refer to 10%. The processor 140 may calculate an accumulated emotion array probability value for each of all the passengers in such a method.

Next, the processor 140 may calculate an emotion rate of all the passengers using the accumulated emotion array probability value of each of all the passengers. When there are 4 persons who ride in the vehicle, the processor 140 may add a third emotion probability of a No. 1 passenger, a third emotion probability of a No. 2 passenger, a third emotion probability of a No. 3 passenger, and a third emotion probability of a No. 4 passenger and may divide the added value by the number Nt (=4) of persons who ride in the vehicle to calculate an average emotion rate Rtm(k) of all the passengers. As an example, when Rtm(1)=0.67, Rtm(2)=0.32, Rtm(3)=0.22, Rtm(4)=0.83, and Rtm(5)=0.12, an average emotion probability (or an average emotion rate) of a first emotion for all the passengers may refer to 67%, an average emotion probability of a second emotion for all the passengers may refer to 32%, an average emotion probability of a third emotion for all the passengers may refer to 22%, an average emotion probability of a fourth emotion for all the passengers may refer to 83%, and an average emotion probability of a fifth emotion for all the passengers may refer to 12%.

The processor 140 may select at least one higher emotion in the average emotion rate, that is, the average emotion probability of all the passengers. As an example, when only one higher emotion is selected, the processor 140 may determine the fourth emotion with the highest average emotion probability as an emotional state of the vehicle passenger. As another example, when three higher emotions are selected, the processor 140 may determine the fourth emotion, the first emotion, and the second emotion as emotional states of the vehicle passenger in an order in which the average emotion probability is high. At this time, the emotional state of the vehicle passenger may be selected within about 40% of an emotion type M with regard to personalized customization and the complexity of a sound source.

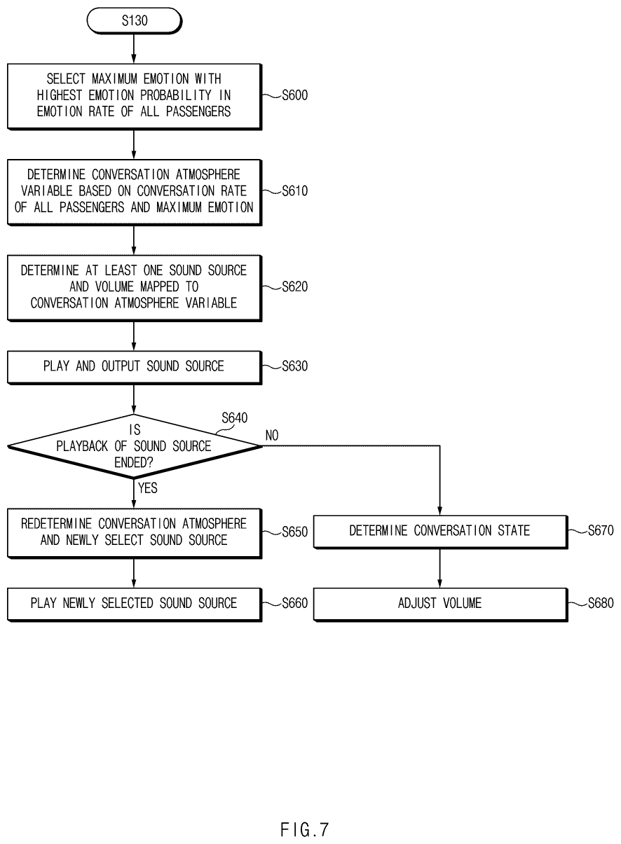

FIG. 7 is a flowchart illustrating a process of analyzing a conversation atmosphere according to an embodiment of the present disclosure.

In S600, the processor 140 may select a maximum emotion based on an emotion rate of all passengers. The processor 140 may select at least one emotion with the highest emotion probability in an emotion rate Rtm(k) of all the passengers. At this time, the maximum emotion may include an emotion within about 40% of the emotion type M. For example, when the emotion type M is 5, the processor 140 may select two types of higher emotions with a high emotion probability as maximum emotions.

In S610, the processor 140 may determine a conversation atmosphere variable based on a conversation rate Rt of all the passengers and a maximum emotion Mm. The processor 140 may determine a conversation atmosphere variable with reference to a lookup table in which a conversation atmosphere according to the conversation rate Rt of all the passengers and the maximum emotion Mm is defined like Table 1 below. For example, when the conversation rate Rt of all the passengers is 0.2 and the maximum emotion Mm is “surprise”, the processor 140 may determine a conversation atmosphere variable Eg as “some conversation and surprise”. The conversation atmosphere variable Eg may be a keyword comprehensively representing a conversation state and an emotional state.

TABLE 1

| | Mm | | | | |
|---|---|---|---|---|---|
| Rt | Joy | Sadness | Anger | Surprise | Calm |
| Less than | No | No | No | No | No |
| 0.05 | conversation | conversation | conversation | conversation | conversation |
| | and joy | and sadness | and anger | and surprise | and calm |
| Greater than | Some | Some | Some | Some | Some |
| or equal to | conversation | conversation | conversation | conversation | conversation |
| 0.05 and less | and joy | and sadness | and anger | and surprise | and calm |
| than 0.3 | | | | | |
| Greater than | Lots of | Lots of | Lots of | Lots of | Lots of |
| or equal to | conversation | conversation | conversation | conversation | conversation |
| 0.3 | and joy | and sadness | and anger | and surprise | and calm |

In S620, the processor 140 may select at least one sound source (or a sound source category) mapped to the conversation atmosphere variable and may determine the volume of the selected at least one sound source. The processor 140 may determine a sound source and the volume mapped to the conversation atmosphere with reference to a lookup table in which the sound source and the volume according to the conversation atmosphere variable are defined like Tables 2 and 3 below. As an example, when the conversation atmosphere variable is “lots of conversation and joy”, the processor 140 may select a sound source category (or a sound source folder), such as light music and classical music with a fast tempo, no lyrics, and a happy feeling. The processor 140 may randomly select any one sound source from the selected sound source category and may determine the volume as 40% of a reference level. The processor 140 may record (or store) the result of selecting the sound source and the volume in the memory 130. Furthermore, when a sound source selected with reference to a recently played history to prevent the same sound source from being repeatedly played is a recently played sound source, the processor 140 may select another sound source in the same category.

TABLE 2

| | | | | |
|---|---|---|---|---|
| No conversation | No conversation | No conversation | No conversation | No conversation |
| and joy | and sadness | and anger | and surprise | and calm |
| Volume: 100% of | Volume: 100% of | Volume: 100% of | Volume: 100% of | Volume: 100% of |
| reference level | reference level | reference level | reference level | reference level |
| Sound source: a | Sound source: a | Sound source: a | Sound source: a | Sound source: a |
| pop song, a | pop song, a | pop song, a | pop song, a | pop song, a |
| Korean pop song, | Korean pop song, | Korean pop song, | Korean pop song, | Korean pop song, |
| or the like with a | or the like with a | or the like with a | or the like with a | or the like with a |
| fast tempo, lyrics, | slow tempo, lyrics, | slow tempo, lyrics, | fast tempo, lyrics, | medium tempo, |
| and a happy | and a sorrowful | and a calm feeling | and a passionate | lyrics, and a light |
| feeling | feeling | | feeling | and bright feeling |
| Some | Some | Some | Some | Some |
| conversation and | conversation and | conversation and | conversation and | conversation and |
| joy | sadness | anger | surprise | calm |
| Volume: 70% of | Volume: 70% of | Volume: 70% of | Volume: 70% of | Volume: 70% of |
| reference level | reference level | reference level | reference level | reference level |
| Sound source: a | Sound source: a | Sound source: a | Sound source: a | Sound source: a |
| pop song with a | pop song or jazz | pop song with a | pop song with a | pop song or jazz |
| fast tempo, few | with a slow | slow tempo, few | fast tempo, few | with a medium |
| lyrics, and a | tempo, few lyrics, | lyrics, and a calm | lyrics, and a | tempo, few lyrics, |
| happy feeling, | and a sorrowful | feeling, light | passionate feeling, | and a light and |
| light music | feeling, light | music without | light music | bright feeling, |
| without lyrics, or | music without | lyrics, or the like | without lyrics, or | light music |
| the like | lyrics, or the like | | the like | without lyrics, or |
| | | | | the like |
| Lots of | Lots of | Lots of | Lots of | Lots of |
| conversation and | conversation and | conversation and | conversation and | conversation and |
| joy | sadness | anger | surprise | calm |
| Volume: 40% of | Volume: 40% of | Volume: 40% of | Volume: 40% of | Volume: 40% of |
| reference level | reference level | reference level | reference level | reference level |
| Sound source: | Sound source: | Sound source: | Sound source: | Sound source: |
| light music, | light music, | light music, | light music, | light music, |
| classical music, | classical music, | classical music, | classical music, | classical music, |
| and the like with a | and the like with a | and the like with a | and the like with a | and the like with a |
| fast tempo, no | slow tempo, no | slow tempo, no | fast tempo, no | medium tempo, |
| lyrics, and a | lyrics, and a | lyrics, and a calm | lyrics, and a | no lyrics, and a |
| happy feeling | mournful feeling | feeling (music | passionate feeling | light and bright |
| (music which does | (music which does | which does not | (music which does | feeling (music |
| not interfere with | not interfere with | interfere with | not interfere with | which does not |
| conversation) | conversation) | conversation) | conversation) | interfere with |
| | | | | conversation) |

As another example, when the conversation atmosphere variable is “no conversation and joy+surprise”, the processor 140 may select a sound source, such as a pop song, a Korean pop song, or rock music with a fast tempo and an intense feeling, and may determine the volume as 100% of the reference level.

TABLE 3

| | |
|---|---|
| No conversation | Volume: 100% of reference level |
| Joy + sadness | Sound source: play only a sound source in which conflicting complex |
| No conversation | emotions correspond to the main emotion (or play a rank-1 emotional |
| Joy + anger | sound source and then play a rank-2 emotional sound source as next |
| | music) |
| No conversation | Volume: 100% of reference level |
| Joy + surprise | Sound source: a pop song, a Korean pop song, rock music, or the like with |
| | a fast tempo and an intense feeling |
| No conversation | Volume: 100% of reference level |
| Joy + calm | Sound source: a pop song, a Korean pop song, or the like with a medium |
| | tempo and a bright and cheerful feeling |
| No conversation | Volume: 100% of reference level |
| Sadness + anger | Sound source: a pop song, a Korean pop song, rock music, or the like with |
| | a slow tempo and a sorrowful feeling |
| No conversation | Volume: 100% of reference level |
| Sadness + surprise | Sound source: a pop song, a Korean pop song, or the like with a fast |
| | tempo and a passionate feeling |
| No conversation | Volume: 100% of reference level |
| Sadness + calm | Sound source: a pop song, light music, jazz, or the like with a slow tempo |
| | and a calm feeling |
| No conversation | Volume: 100% of reference level |
| Anger + surprise | Sound source: a pop song, a Korean pop song, classical music, or the like |
| | with large tempo changes |
| No conversation | Volume: 100% of reference level |
| Anger + calm | Sound source: play only a sound source in which conflicting complex |
| No conversation | emotions correspond to the main emotion (or play a rank-1 emotional |
| Surprise + calm | sound source and then play a rank-2 emotional sound source as next |
| | music) |
| No conversation | Volume: 70% of reference level |
| Joy + sadness | Sound source: play only a sound source in which conflicting complex |
| Some conversation | emotions correspond to the main emotion (or play a rank-1 emotional |
| Joy + anger | sound source and then play a rank-2 emotional sound source as next |
| | music) |
| Some conversation | Volume: 70% of reference level |
| Joy + surprise | Sound source: a pop song, rock music, or the like with a fast tempo and an |
| | intense feeling |
| Some conversation | Volume: 70% of reference level |
| Joy + calm | Sound source: a pop song, light music, or the like with a medium tempo |
| | and a bright and cheerful feeling |
| Some conversation | Volume: 70% of reference level |
| Joy + anger | Sound source: a pop song, rock music, or the like with a slow tempo and a |
| | sorrowful feeling |
| Some conversation | Volume: 70% of reference level |
| Sadness + surprise | Sound source: a pop song, light music, or the like with a fast tempo and |
| | passionate feeling |
| Some conversation | Volume: 70% of reference level |
| Sadness + calm | Sound source: a pop song, light music, jazz, or the like with a slow tempo |
| | and a calm feeling |
| Some conversation | Volume: 70% of reference level |
| Anger + surprise | Sound source: a pop song, classical music, or the like with large tempo |
| | changes |
| Some conversation | Volume: 100% of reference level |
| Anger + calm | Sound source: play only a sound source in which conflicting complex |
| Some conversation | emotions correspond to the main emotion (or play a rank-1 emotional |
| Surprise + calm | sound source and then play a rank-2 emotional sound source as next |
| | music) |
| Lots of conversation | Volume: 40% of reference level |
| Joy + sadness | Sound source: play only a sound source in which conflicting complex |
| Lots of conversation | emotions correspond to the main emotion (or play a rank-1 emotional |
| Joy + anger | sound source and then play a rank-2 emotional sound source as next |
| | music) |
| Lots of conversation | Volume: 40% of reference level |
| Joy + surprise | Sound source: a pop song, rock music, or the like with a fast tempo and an |
| | intense feeling |
| Lots of conversation | Volume: 40% of reference level |
| Joy + calm | Sound source: a pop song, light music, or the like with a medium tempo |
| | and a bright and cheerful feeling |
| Lots of conversation | Volume: 40% of reference level |
| Sadness + anger | Sound source: a pop song, rock music, or the like with a slow tempo and a |
| | sorrowful feeling |
| Lots of conversation | Volume: 40% of reference level |
| Sadness + surprise | Sound source: a pop song, light music, or the like with a fast tempo and a |
| | passionate feeling |
| Lots of conversation | Volume: 40% of reference level |
| Sadness + calm | Sound source: a pop song, light music, jazz, or the like with a slow tempo |
| | and a calm feeling |
| Lots of conversation | Volume: 40% of reference level |
| Anger + surprise | Sound source: a pop song, a Korean pop song, classical music, or the like |
| | with large tempo changes |
| Lots of conversation | Volume: 100% of reference level |
| Anger + calm | Sound source: play only a sound source in which conflicting complex |
| Lots of conversation | emotions correspond to the main emotion (or play a rank-1 emotional |
| Surprise + calm | sound source and then play a rank-2 emotional sound source as next |
| | music) |

In S630, the processor 140 may play and output the selected at least one sound source. The processor 140 may play the selected sound source with the determined volume using a player. The processor 140 may output an audio signal of the played sound source to the interior of the vehicle using the speaker 120. In S640, the processor 140 may determine whether the playback of the sound source is ended. The processor 140 may determine whether the playback of the sound source which is being currently played is ended.

When it is determined that the playback of the sound source is ended, in S650, the processor 140 may redetermine a conversation atmosphere and may newly select a sound source.

When the playback of the sound source which is being currently played is ended, in S660, the processor 140 may play the newly selected sound source.

When it is determined that the playback of the sound source is not ended, in S670, the processor 140 may determine a conversation state. The processor 140 may determine whether lips are open to calculate a conversation rate of all passengers and may determine a conversation state based on the calculated conversation rate of all the passengers.

In S680, the processor 140 may adjust the volume of the sound source which is being currently played based on the determined conversation state.

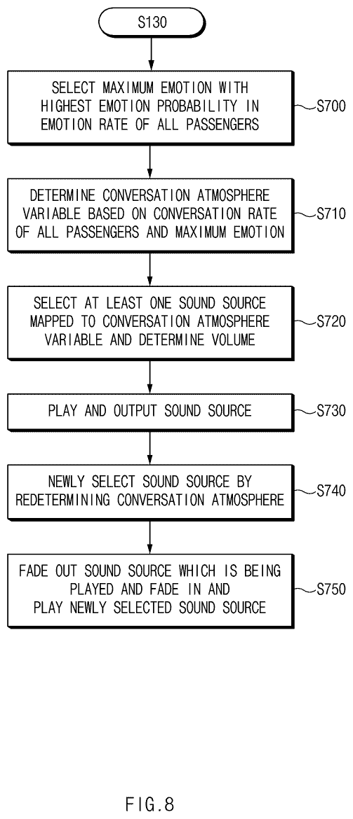

FIG. 8 is a flowchart illustrating a process of analyzing a conversation atmosphere according to another embodiment of the present disclosure.

In S700, a processor 140 may select a maximum emotion with the highest emotion probability among emotion rates of all passengers. For example, when the emotion rates of all the passengers, for example, probabilities (or rates) of joy, sadness, anger, surprise, and calm are 50%, 4%, 10%, 26%, and 10%, the processor 140 may select the maximum emotion as “joy” because “joy” has the highest probability.

In S710, the processor 140 may determine a conversation atmosphere variable based on a conversation rate of all the passengers and the maximum emotion. The processor 140 may determine the conversation atmosphere variable with reference to a lookup table in which a conversation atmosphere according to a conversation rate Rt of all the passengers and a maximum emotion Mm is defined like Table 1 above.

In S720, the processor 140 may select at least one sound source mapped to the conversation atmosphere variable and may determine the volume of the selected at least one sound source. The processor 140 may determine a sound source and a volume mapped to the conversation atmosphere with reference to a lookup table in which the sound source and the volume according to the conversation atmosphere are defined like Tables 2 and 3.

In S730, the processor 140 may play and output the selected at least one sound source as background music. When two or more sound sources are selected, the processor 140 may sequentially or randomly play the selected two or more sound sources in a predetermined order.

In S740, the processor 140 may redetermine a conversation atmosphere and may newly select a sound source. The processor 140 may monitor a conversation state and an emotional state of a vehicle passenger, while the background music is output, and may redetermine a conversation atmosphere of the vehicle passenger based on the monitored result. When the redetermined conversation atmosphere is different from the previously determined conversation atmosphere, the processor 140 may newly select a sound source which matches the redetermined conversation atmosphere. When the redetermined conversation atmosphere is the same as the previously determined conversation atmosphere, the processor 140 may fail to select the sound source which matches the redetermined conversation atmosphere.

In S750, the processor 140 may fade out the sound source which is being played and may fade in and play the newly selected sound source. The processor 140 may determine the volume based on the redetermined conversation atmosphere.

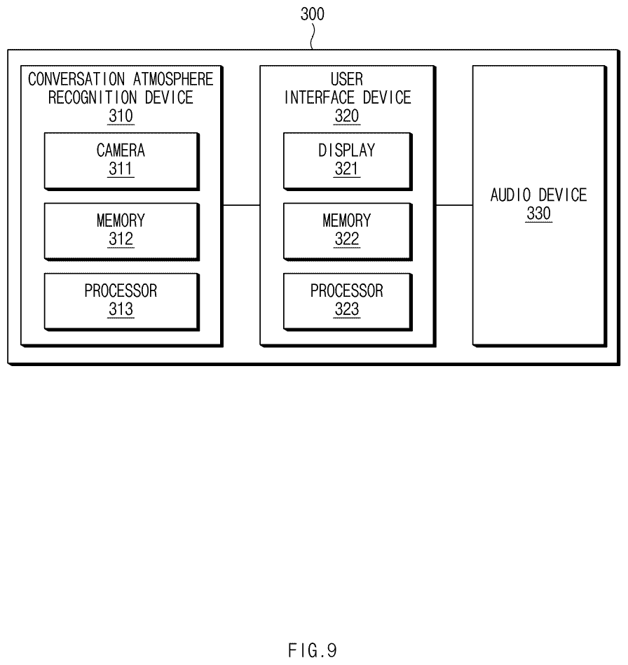

FIG. 9 is a block diagram illustrating a sound providing system according to another embodiment of the present disclosure.

A sound providing system 300 may be loaded into a vehicle in which there is no driver, for example, a robotaxi. The sound providing system 300 may determine a conversation state and an emotional state of at least one passenger who rides in the vehicle and may automatically determine and provide a sound source and/or a volume based on the determined result.

The sound providing system 300 may include a conversation atmosphere recognition device 310 for performing data communication over a vehicle network, a user interface device 320, and an audio device 330. The vehicle network may be implemented as a controller area network (CAN), a media oriented systems transport (MOST) network, a local interconnect network (LIN), an Ethernet, X-by-Wire (Flexray), and/or the like.

The conversation atmosphere recognition device 310 may determine a conversation atmosphere of at least one passenger who rides in the vehicle. Such a conversation atmosphere recognition device 310 may include a camera 311, a memory 312, and a processor 313. Because the camera 311, the memory 312, and the processor 313 correspond to the camera 110, the memory 130, and the processor 140 shown in FIG. 1, respectively, a detailed description of each component will be omitted.

The camera 311 may be installed in the vehicle to capture at least one passenger who rides in the vehicle. A video camera, such as a webcam, may be used as the camera 311. For example, a webcam with 720p resolution, a 120-degree angle of view, and a 30 fps frame rate may be applied to the camera 311.

The memory 312 may store an AI algorithm such as machine learning or deep learning. The memory 312 may include an MTCNN model-based face recognition algorithm, face feature point model-based mouth shape estimation logic, Mini Xception model-based emotion estimation logic, a conversation atmosphere determination algorithm, and/or the like.

The processor 313 may obtain a face image of the at least one passenger using the camera 311. The processor 313 may extract at least some mouth feature points from the face image for each passenger. The processor 313 may determine whether lips are open for each passenger based on positions (or coordinates) of the extracted at least some mouth feature points. The processor 313 may calculate a lip opening frequency for each passenger by determining whether the lips are open for each passenger. The processor 313 may calculate an average lip opening frequency of all passengers using the lip opening frequency for each passenger and may determine a conversation state of at least one passenger based on the average lip opening frequency of all the processors.

Furthermore, the processor 313 may recognize a facial expression for each passenger from the face image for each passenger. The processor 313 may determine an emotion rate for each passenger based on the recognized facial expression for each passenger. The processor 313 may calculate an average emotion rate of all the passengers using the emotion rate for each passenger. The processor 313 may determine an emotional state of all the passengers based on the average conversation rate of all the passengers. The processor 313 may select an emotional item (or an emotion type) with the highest rate in the average emotion rate of all the passengers as a maximum emotion (or an emotional state of all the passengers).

The processor 313 may determine a conversation atmosphere based on the determined conversation state and the determined emotional state of the at least one passenger. The processor 313 may transmit the result of determining the conversation atmosphere to the user interface device 320 over the vehicle network.

The user interface device 320 may be installed in the vehicle such that the passenger is able to monitor his or her own emotional state and conversation state. For example, the user interface device 320 may be installed on the front of a vehicle seat (e.g., a headrest of a front seat or the like). A user interface (UI) application may be installed in the user interface device 320. A tablet or the like may be used as the user interface device 320.

The user interface device 320 may include a display 321, a memory 322, and a processor 323.

The display 321 may output visual information. The display 321 may include a liquid crystal display (LCD), a thin film transistor-LCD (TFT-LCD), an organic light-emitting diode (OLED) display, a flexible display, a three-dimensional (3D) display, a transparent display, and/or the like. The display 321 may be implemented as a touch screen coupled to a touch sensor (e.g., a touch film, a touch pad, or the like) to be used as an input device as well as an output device.

The memory 322 may store a program for an operation of the processor 323. Furthermore, the memory 322 may store a lookup table in which a sound source and a volume according to a conversation atmosphere are defined. The memory 322 may store at least one sound source classified for each sound source category (or music genre).

The processor 323 may receive the result of determining the conversation atmosphere from the conversation atmosphere recognition device 310. The processor 323 may select at least one sound source mapped to the result of determining the conversation atmosphere (or the conversation atmosphere variable) with reference to the lookup table stored in the memory 322.

The processor 323 may play the selected at least one sound source using a media player previously installed in the user interface device 320. The processor 323 may sequentially or randomly play the selected at least one sound source in a predetermined order. The processor 323 may adjust the volume of the played sound source based on the result of determining the conversation atmosphere.

The processor 323 may transmit the played audio signal of the sound source to the audio device 330.

The audio device 330 may receive the audio signal transmitted from the user interface device 320. The audio device 330 may output the received audio signal to the interior light of the vehicle through an embedded at least one speaker.

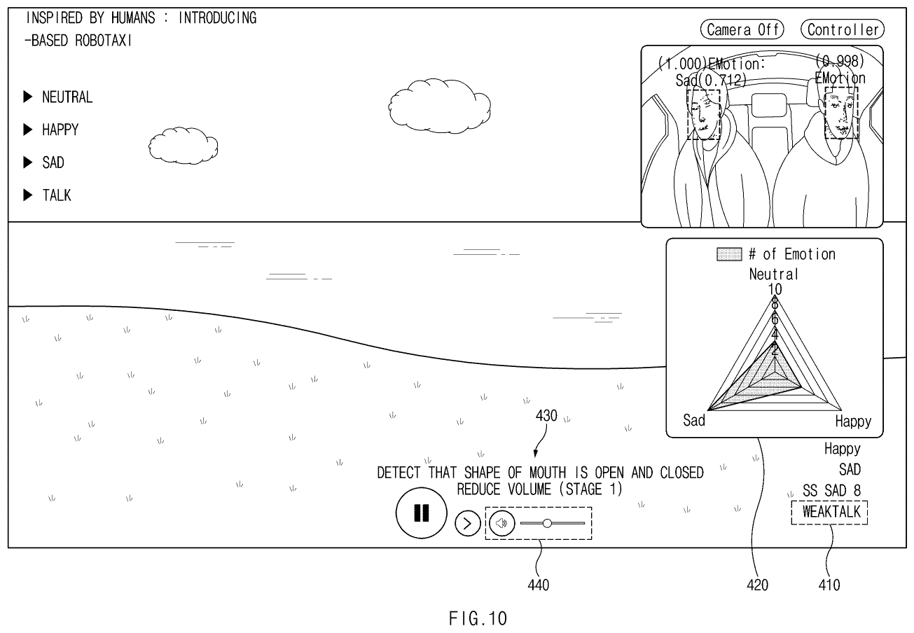

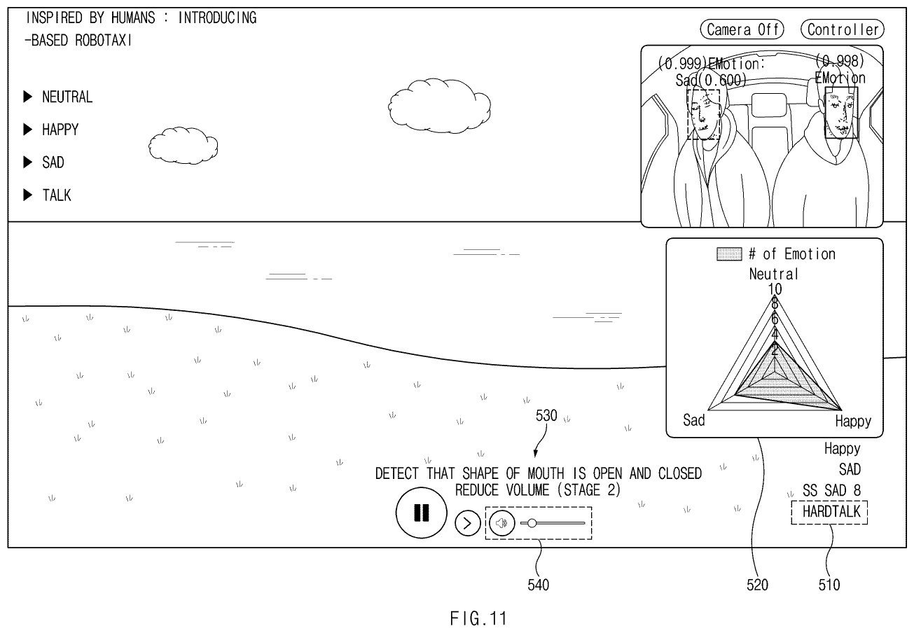

FIGS. 10 and 11 are drawings illustrating an example of a display screen of a user interface device according to another embodiment of the present disclosure.

Referring to FIG. 10, when the conversation rate Rt of all passengers is 0.18 and when the emotion rate Rtm(“SAD”) of all the passengers is 0.95, the emotion rate Rtm(“HAPPY”) of all the passengers is 0.41, and the emotion rate Rtm(“NEUTRAL”) of all the passengers is 0.38, the conversation atmosphere recognition device 310 may determine that the conversation state is “weaktalk” and that the maximum emotion is “SAD”. The conversation atmosphere recognition device 310 may determine a conversation atmosphere variable Eg as “some conversation and sadness” based on the conversation state and the maximum emotion. The user interface device 320 may select a sound source, such as light music with a slow tempo and a mournful feeling (e.g., music by AI), as background music mapped to the conversation atmosphere variable. The user interface device 320 may play the selected sound source. At this time, the user interface device 320 may display a determined conversation state 410 and an emotional state 420 on a screen of the display 321. Furthermore, the conversation atmosphere recognition device 310 may adjust the volume of the played sound source to 40% of the maximum volume. At this time, when there is a change compared to the existing volume due to volume adjustment, the user interface device 320 may output visual information, such as a message 430 and/or a volume adjustment bar 440, indicating the change.

Referring to FIG. 11, when the conversation rate Rt of all passengers is 0.35 and when the emotion rate Rtm(“SAD”) of all the passengers is 0.58, the emotion rate Rtm(“HAPPY”) of all the passengers is 0.97, and the emotion rate Rtm(“NEUTRAL”) of all the passengers is 0.36, the conversation atmosphere recognition device 310 may determine that the conversation state is “Hardtalk” and that the maximum emotion is “HAPPY”. The conversation atmosphere recognition device 310 may determine a conversation atmosphere variable Eg as “lots of conversation and joy” based on the conversation state and the maximum emotion. The conversation atmosphere recognition device 310 may select a sound source, such as light music with a fast tempo and a happy feeling (or music composed by AI), as background music mapped to the conversation atmosphere variable. The user interface device 320 may play the selected sound source. At this time, the user interface device 320 may display a determined conversation state 510 and an emotional state 520 on a screen of the display 321. Furthermore, the conversation atmosphere recognition device 310 may adjust the volume of the played sound source to 20% of the maximum volume. At this time, when there is a change compared to the existing volume due to volume adjustment, the user interface device 320 may output visual information, such as a message 530 and/or a volume adjustment bar 540, indicating the change.

Embodiments of the present disclosure may recognize a conversation atmosphere of passengers who ride in a vehicle and may provide music which matches the recognized conversation atmosphere, thus allowing the passengers to smoothly engage in conversation.

Furthermore, embodiments of the present disclosure may play a type of sound source which does not interfere with conversation with small volume, when passengers talk a lot while driving, thus allowing the passengers to remain calm and focus more on conversation.

Furthermore, embodiments of the present disclosure may play music which is not boring with relatively large volume, when there is little or no conversation between passengers while driving, thus allowing the passengers to focus more on the music.

Furthermore, embodiments of the present disclosure may select a suitable type of sound source depending on a conversation atmosphere (or a conversation situation) and may play the selected sound source at a volume determined based on the conversation atmosphere, thus allowing passengers to have natural conversations with the right balance between conversation and music and comfortably enjoy the music.

Hereinabove, although embodiments of the present disclosure have been described with reference to exemplary embodiments and the accompanying drawings, the present disclosure is not limited thereto, but it may be variously modified and altered by those skilled in the art to which the present disclosure pertains without departing from the spirit and scope of the present disclosure claimed in the following claims. Therefore, embodiments of the present disclosure are not intended to limit the technical spirit of the present disclosure, but they are provided only for illustrative purposes. The scope of the present disclosure should be construed on the basis of the accompanying claims, and all the technical ideas within the scope equivalent to the claims should be included in the scope of the present disclosure.

What is claimed is:

1. A sound providing apparatus, the apparatus comprising:
a camera;
one or more processors; and
a storage device storing a program to be executed by the one or more processors, the program including instructions to:
obtain a face image of each passenger in a vehicle using the camera;
determine a conversation state of each passenger based on the face image of each passenger;
determine an emotional state of each passenger based on the face image of each passenger;
determine a conversation atmosphere based on the conversation state and the emotional state of each passenger;
select a sound source mapped to the conversation atmosphere; and
play and output the sound source.

2. The apparatus of claim 1, wherein the program further includes instructions to:
extract positions of mouth feature points from the face image of each passenger;
calculate a lip aspect ratio for each passenger based on the positions of the mouth feature points;
determine whether lips of each passenger are open based on the lip aspect ratio;
count a lip opening count for each passenger based on a determination result of whether the lips of each passenger are open;
calculate a conversation rate for each passenger based on the lip opening count for each passenger; and
calculate an average conversation rate of all passengers based on the conversation rate for each passenger.

3. The apparatus of claim 2, wherein the program further includes instructions to extract the positions of the mouth feature points using a face feature point detection algorithm.

4. The apparatus of claim 1, wherein the program further includes instructions to:
extract positions of mouth feature points from the face image of each passenger;
determine a lip open state value for each passenger based on the positions of the mouth feature points using an artificial intelligence algorithm;
calculate a conversation rate for each passenger based on the lip open state value for each passenger; and
calculate an average conversation rate of all passengers based on the conversation rate for each passenger.

5. The apparatus of claim 1, wherein the program further includes instructions to:
recognize a facial expression for each passenger from the face image of each passenger;
estimate an emotion array probability for each passenger based on the facial expression for each passenger;
calculate an emotion rate for each passenger based on the emotion array probability for each passenger; and
calculate an average emotion rate of all passengers based on the emotion rate for each passenger.

6. The apparatus of claim 5, wherein the program further includes instructions to determine a higher emotion with a high probability in the average emotion rate of all passengers as the emotional state of all passengers.

7. The apparatus of claim 1, wherein the program further includes instructions to:
redetermine the conversation state of each passenger while the sound source plays; and
adjust a volume of the sound source based on the redetermined conversation state of each passenger.

8. The apparatus of claim 1, wherein the program further includes instructions to:
redetermine the conversation atmosphere in a case in which playback of the sound source is ended;
select a second sound source mapped to the redetermined conversation atmosphere; and
play the second sound source.

9. The apparatus of claim 1, wherein the program further includes instructions to:
redetermine the conversation atmosphere while the sound source plays;
select a second sound source mapped to the redetermined conversation atmosphere; and
fade out the sound source and fade in and play the second sound source.

10. The apparatus of claim 1, wherein the program further includes instructions to adjust a volume of the sound source based on the conversation atmosphere.

11. A sound providing method, the method comprising:
obtaining a face image of each passenger in a vehicle using a camera;
determining a conversation state of each passenger based on the face image of each passenger;
determining an emotional state of each passenger based on the face image of each passenger;
determining a conversation atmosphere based on the conversation state and the emotional state of each passenger;
selecting a sound source mapped to the conversation atmosphere; and
playing and outputting the sound source.

12. The method of claim 11, wherein determining the conversation state of each passenger comprises:
extracting positions of mouth feature points from the face image of each passenger;
calculating a lip aspect ratio for each passenger based on the positions of the mouth feature points;
determining whether lips of each passenger are open based on the lip aspect ratio;
counting a lip opening count for each passenger based on a determination result of whether the lips of each passenger are open;
calculating a conversation rate for each passenger based on the lip opening count for each passenger; and
calculating an average conversation rate of all passengers based on the conversation rate for each passenger.

13. The method of claim 12, wherein extracting the positions of the mouth feature points comprises extracting the positions of the mouth feature points using a face feature point detection algorithm.

14. The method of claim 11, wherein determining the conversation state of each passenger comprises:
extracting positions of mouth feature points from the face image of each passenger;
determining a lip open state value for each passenger based on the positions of the mouth feature points using an artificial intelligence algorithm;
calculating a conversation rate for each passenger based on the lip open state value for each passenger; and
calculating an average conversation rate of all passengers based on the conversation rate for each passenger.

15. The method of claim 11, wherein determining the emotional state of each passenger comprises:
recognizing a facial expression for each passenger from the face image of each passenger;
estimating an emotion array probability for each passenger based on the facial expression for each passenger;
calculating an emotion rate for each passenger based on the emotion array probability for each passenger; and
calculating an average emotion rate of all passengers based on the emotion rate for each passenger.

16. The method of claim 15, wherein determining the emotional state of each passenger comprises determining a higher emotion with a high probability in the average emotion rate of all passengers as the emotional state of each passenger.

17. The method of claim 11, further comprising:
redetermining the conversation state of each passenger while the sound source plays; and
adjusting a volume of the sound source based on the redetermined conversation state.

18. The method of claim 11, further comprising:
redetermining the conversation atmosphere of each passenger in a case in which playback of the sound source is ended;
selecting a second sound source mapped to the redetermined conversation atmosphere; and
playing the second sound source.

19. The method of claim 11, further comprising:
redetermining the conversation atmosphere while the sound source plays;
selecting a second sound source mapped to the redetermined conversation atmosphere; and
fading out the sound source and fading in and playing the second sound source.

20. The method of claim 11, further comprising determining a volume of the sound source based on the conversation atmosphere.
